(19) United States
(12) Patent Application Publication
(10) Pub. No.: US 2011/0266212 A1
(43) Pub. Date: Nov. 3, 2011

(54) HORIZONTAL BELT FILTER

(75) Inventors: Jared Quilter, North Heber City, UT (US); Brandon Rose, Taylorsville, UT (US)

(73) Assignee: FLSmidth A/S, Valby (DK)

(21) Appl. No.: 13/142,713

(22) PCT Filed: Dec. 23, 2009
(86) PCT No.: PCT/US09/69376

§ 371 Date: Jun. 29, 2011

Related U.S. Application Data
(60) Provisional application No. 61/204,018, filed on Dec. 30, 2008.

(51) Int. Cl. B01D 33/04

(52) U.S. Cl. 210/400

(57) ABSTRACT

A belt filter for separating liquids from solids in a slurry feed comprising a frame supporting a porous filter medium arranged over a moving carrier belt. The medium is adaptable to receive the feed and separate liquid filtrate therefrom. A vacuum pan is provided for collecting liquid filtrate separated from the feed. The vacuum pan is a rectangular trough having an open end located directly underneath the carrier belt, with the length of said vacuum pan being situated in the direction of movement of the carrier belt. A filtrate manifold is provided for receiving the filtrate from the vacuum pan, with the filtrate manifold being attached to and located directly underneath the vacuum pan to form an integral assembly that facilitates performing maintenance on the vacuum pan.

### RELATED APPLICATIONS

This Application claims the benefit of earlier filed U.S. Provisional Patent Application No. 61/204,018, filed on 30 Dec. 2008 in the United States Patent and Trademark Office. Said Application is expressly incorporated herein, in its entirety, by this reference.

### TECHNICAL FIELD

This invention relates generally to separation of solids from liquids in a slurry feed by filtration and in particular to horizontal belt filters in which an endless belt of filter medium is moved intermittently over one or more physically fixed vacuum filtration sections thence to cake discharge and return to filtration.

### BACKGROUND OF THE INVENTION

Devices employing an endless belt trained about a pair of rotating drums and used to convey objects from one location to another have been known for years. A readily recognized example of such a device is the common conveyor belt. Filters in general, and belt filters in particular, have also long been known in the art.

Belt filters typically include a porous filter medium which is arranged over a moving carrier belt. The medium is oftentimes configured as an endless web thereby facilitating its being urged in a circuitous path by the carrier belt. The belt is also generally constructed in an endless configuration. Feed slurry is uniformly distributed over the full width of the porous filter medium by a top feed arrangement.

The belt is typically trained over a pair of rotating drums located on either end of the belt filter. An endless rubber belt with traversing grooves drains the filtrate towards holes positioned along the belt. The filter cloth retains the cake after the filtrate is removed and moves together with the belt. Essentially, the system comprises an endless belt that travels through a working run that includes a slurry feed section, a filter section, and a return run that conducts the belt leaving the filter section through necessary cake discharge, belt wash, alignment, etc. thence back to the slurry feed section.

A suction means is oftentimes associated with the medium/carrier belt assembly for purposes of expediting the filtering process. In one embodiment, the suction means for extracting filtrate from the cake is positioned beneath the carrier belt. The belt defines a plurality of apertures therein which communicate the suction means with the filter medium positioned atop the belt. A conventional suction means used in this environment includes a vacuum pan located below the belt that is mounted along the filter and over which the belt passes. Dewatering is accomplished by applying a vacuum to the bottom of the carrier belt. Differential pressure thereby draws slurry liquor through the filter cloth, along traversing grooves in the endless rubber belt to drain holes, i.e. the aforementioned apertures, centered over the vacuum pan. Cake is discharged as the filter media is separated from the carrier belt. Multiple wash sprays located on the underside of the horizontal belt filter clean the carrier belt and filter media independently to extend the service life of both.

The vacuum pan directs the filtrate to a separate filtrate manifold which is located outside of the horizontal belt filter assembly. The filtrate manifold collects the mother and wash liquids and directs the same to one or more vacuum receivers. The vacuum pan is connected to one or more filtrate manifolds by a number of small filtrate hoses. As the vacuum pan requires periodic maintenance to, among other things, clean out fines that have settled inside, replace the wear belts and replace the wear blocks, the hoses leading to the filtrate manifold, along with numerous fasteners and other components, must be disconnected, after which the vacuum pan is lowered to enable the service person to gain access to the vacuum pan to perform the required maintenance. This disassembly procedure adds a significant amount of time to maintenance procedures and it is often difficult to obtain full access to the vacuum pan.

It is one object of this invention, therefore, to decrease the time and difficulty in performing maintenance on the vacuum pan of a horizontal belt filter.

### SUMMARY OF THE INVENTION

The above and other objects are realized by the present invention, in which there is a horizontal belt filter in which the vacuum pan and the filtrate manifold are combined into one unit that is integral with the horizontal belt filter. The combination nature of the unit results in very few connections that must be disassembled for maintenance on the vacuum pan. Furthermore, in a preferred embodiment of the invention the combined unit is constructed for easy lowering and rotation thus facilitating its access for maintenance.

In order that the invention may be more readily understood and carried into effect, reference is made to the accompanying drawings and description thereof which are offered by way of example only and not in limitation of the invention, the scope of which is defined solely by the appended claims including equivalents embraced therein.

### BRIEF DESCRIPTION OF THE DRAWINGS

FIG. 1 is a schematic front sectional view of a prior art horizontal belt filter.

FIG. 2 is a schematic front sectional view of a prior art vacuum pan being lowered for maintenance.

FIG. 3 is a schematic front sectional view of a horizontal belt filter of the present invention showing a portion of a belt filter having more than one combined vacuum pan and filtrate manifolds.

FIG. 4 is a schematic front sectional detail view of the combined vacuum pan and filtrate manifold.

FIG. 5 is a schematic front sectional detail view of the combined vacuum pan and filtrate manifold of the present invention shown in the lowered position.

FIG. 6 is a schematic front sectional detail view of the combined vacuum pan and filtrate manifold of the present invention shown in the rotated position,

FIG. 7 is a schematic front sectional detail view of the combined vacuum pan and filtrate manifold showing the rotation mechanism.

FIG. 8 is an isometric view of the combined vacuum pan and filtrate manifold of the present invention.

FIG. 9 is a view of a portion of the frame of a belt filter 9 (without the belt filter or filter medium) in which there is utilized two combined vacuum pan and filtrate manifold devices of the present invention arranged in parallel.

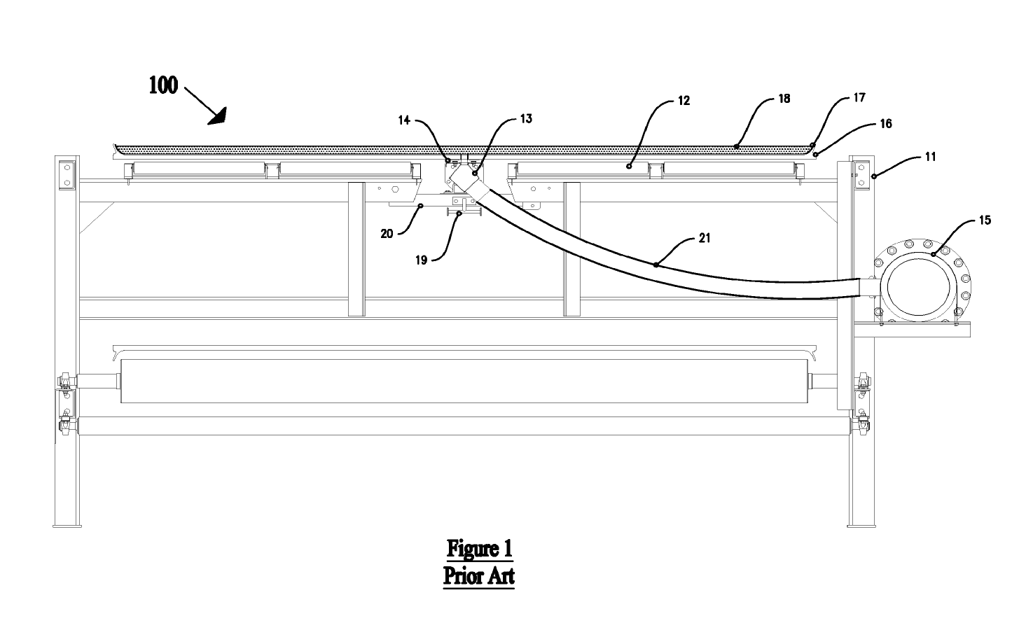

FIG. 1 depicts a sectional view across the width of a horizontal belt filter 100. Belt filter 100 comprises a main frame 11 on which are mounted one or more prior art vacuum pans 13. A deck 12 is attached to frame 11. Deck 12 is mounted underneath endless conveying and drainage belt 16 and is designed to support drainage belt 16 and cake 18.

Drainage belt 16 has traversing grooves (not shown) that drain the filtrate towards holes (not shown) positioned along the belt. Drainage belt 16 supports filter cloth 17 that retains the cake 18 and moves together with the belt. Generally, filter cloth 17 is made from porous synthetic materials such as polypropylene or polyester. The drainage belt will move in the same direction as the length of the vacuum pan, which is essentially a rectangular trough. Once the drainage belt reaches the end of the vacuum pan 13 the cake drying portion of the filter cycle terminates and the cloth leaves the rubber belt. The cloth continues moving, changes direction over a discharge roll and the cake drops through a chute for further handling. After the filter cloth discharges the cake at the tail end of the belt filter it can be washed before returning to the head end of the belt filter.

Vacuum pan 13 extends down the length of the belt filter in the same direction as the movement of the belt and is equipped with one or more bottom outlet vacuum hoses 21 for withdrawal of air and filtrate to a separate filtrate manifold 15 lying outside of the main frame structure. In filtrate manifold 15 the large volume inside the manifold pipe decreases the velocity of the filtrate entering the manifold and helps to separate the air from the filtrate which is then fed to a vacuum receiver (not shown).

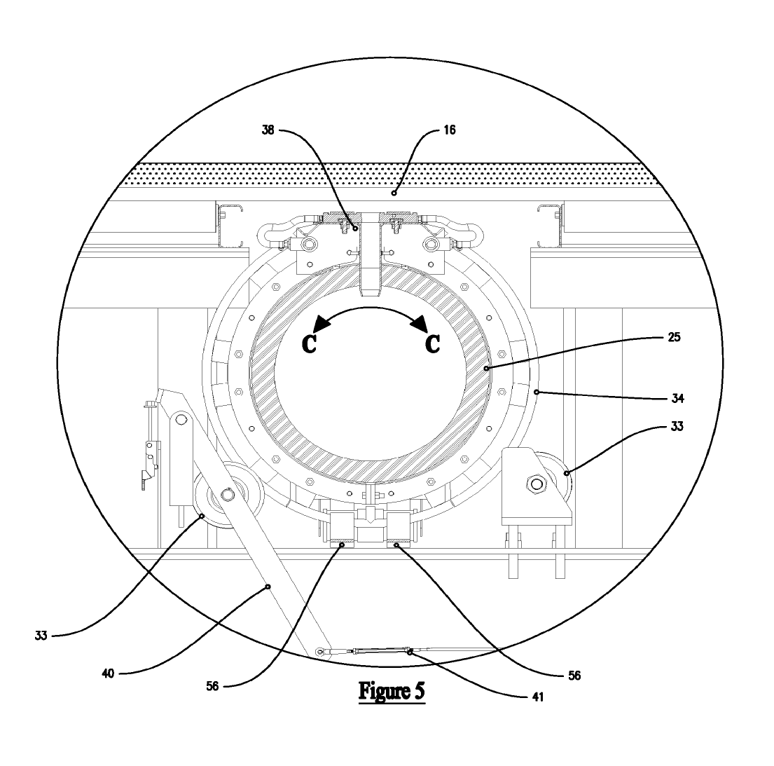

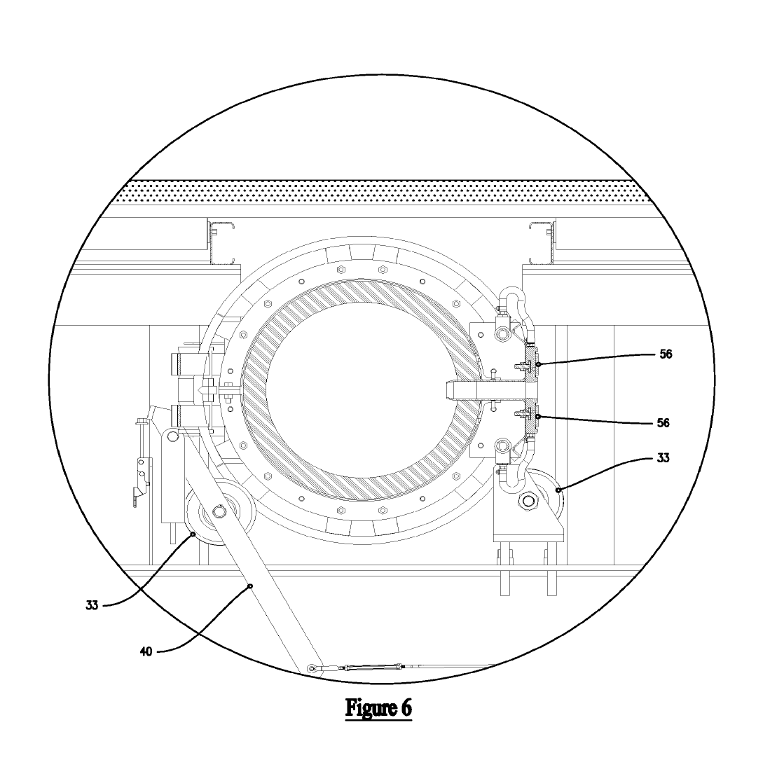

Vacuum pan 13 at its topside has low friction synthetic wear belt slide blocks 14 that seal through intermediate wear belts (not shown in this view, but similar to those shown as numeral 56 in FIGS. 5 and 6) between the bottom side of the belt and the vacuum pan. Since drainage belt 16 is the most expensive part of the filter these endless narrow intermediate wear belts serve as a sacrificial component that takes the wear between the surfaces, protects the drainage belt 16 and secures against vacuum leaks. Wear belt slide blocks 14 and wear belt bottom support 19 also serve to support and guide the wear belts.

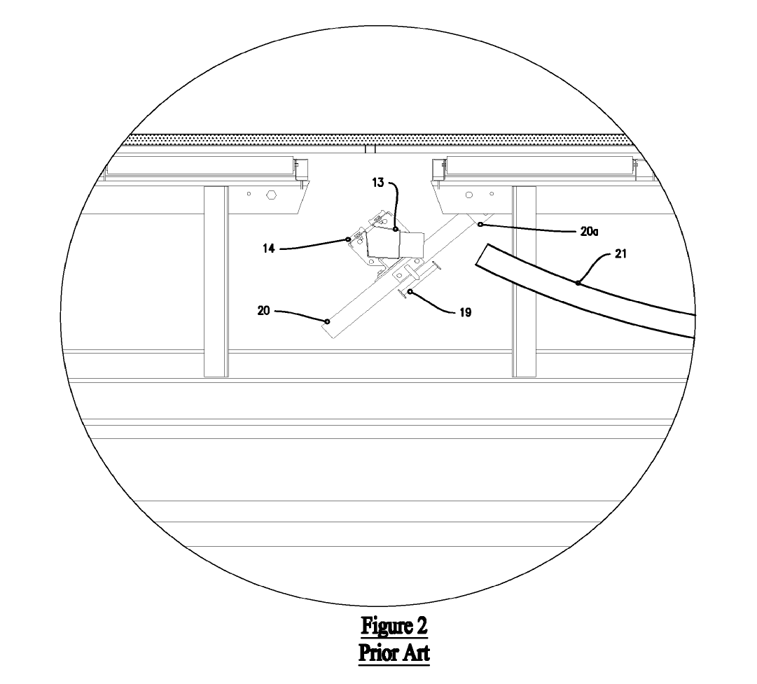

Vacuum pan 13 is designed to be moved to a position to enable maintenance to be performed. FIG. 2 depicts a typical prior art method of undertaking the maintenance of vacuum pan 13. Vacuum hose 21 is disengaged from vacuum pan 13, vacuum pan lowering arm 20 is disengaged from the belt filter frame, with vacuum pan lowering arm 20 being hinged and designed to rotatable around end 20a. However, even with this design maintenance is still difficult. Many hoses have to be disconnected and, furthermore, it is still difficult to have a clear, direct access to vacuum pan 13.

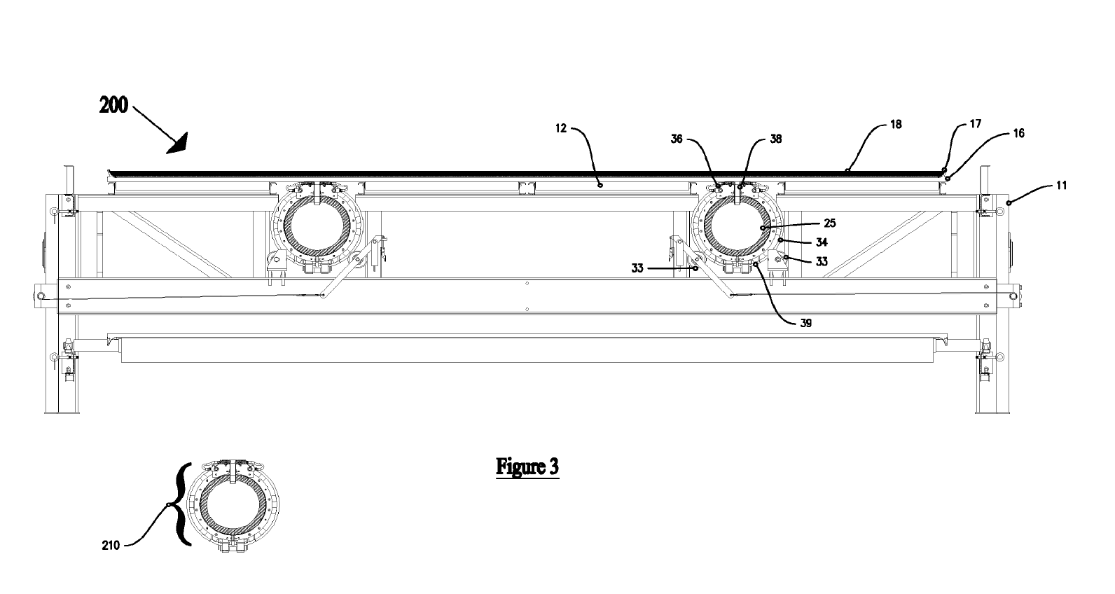

According to the present invention (FIG. 3), certain elements of the horizontal belt filter 200 of the present invention are similar to in form and function to like elements in the prior art belt filter. Thus, filter 200 comprises a main frame 11, a deck 12 supporting drainage belt 16 and cake 18 and filter cloth 17. Belt filter 200 also contains one or more vacuum pans 38 extending down the length of the belt filter directly underneath drainage belt 16, collection troughs 36 and wear belt bottom support 39. Filter 200 is unique, however, from the prior art belt filter in that filtrate manifold 25 is placed underneath drainage belt 16 and furthermore is directly underneath and physically connected to vacuum pan 38 as an integrated assembly 210. Filtrate that is collected into vacuum pan 38 is thereafter directly drawn into filtrate manifold 25. Filtrate manifold 25 is in the preferred embodiment essentially cylindrical, with its longitudinal axis parallel to the longitudinal axis of vacuum pan 13. Filtrate manifold 25, like vacuum pan 38, is situated lengthwise underneath drainage belt 16. When there is more than one vacuum pan 38 associated with a belt filter 200 each will have a dedicated filtrate manifold to which it is attached.

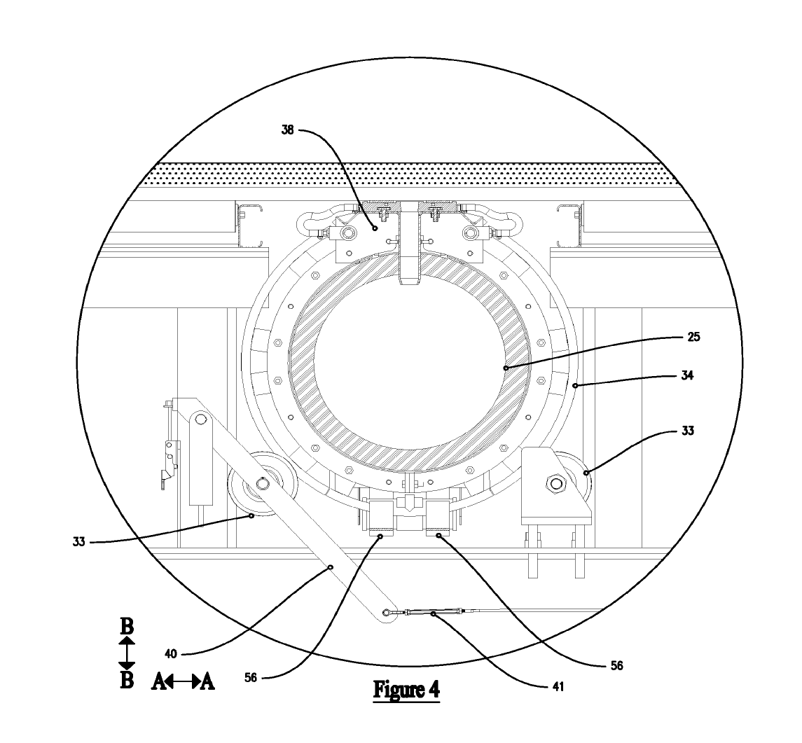

In the depicted embodiment, filtrate manifold 25 is clamped to vacuum pan 38 by support rings 34. The combined vacuum pan/filtrate manifold assembly 210 is supported at intermediate locations by rolling support members 33. FIG. 4 depicts greater detail of the depicted embodiment. [0001] One of the rolling support members 33 at each location is connected to a swing arm 40 which allows the rolling support member to move the entire vacuum pan/filtrate manifold assembly widthwise in the direction A [symbol] A and also vertically in the direction B [symbol] B. The swing arm 40 is connected to a connecting rod 41 which controls the movement of the swing arm. This movement can be accomplished by the use of cables, mechanical screw jacks, pneumatic cylinders, or hydraulics, to name a few.

FIG. 5 shows the swing arm 40 in the lowered position. This action serves to lower the vacuum pan/filtrate manifold assembly 210 away from the drainage belt 16 to allow clearance for the assembly to rotate about the longitudinal axis of the filtrate manifold pipe 25 in the direction C [symbol] C.

FIG. 6 shows the vacuum pan/filtrate manifold assembly in a rotated position. This position facilitates maintenance on the vacuum pan 38, including replacing the wear belts 56 and other wear parts located on top of the vacuum pan. This enables the assembly to be rotated at least 90° to thereby allow horizontal access to the vacuum pan 38 and specifically to the upper portion of the vacuum pan 38, which can not be easily achieved with the prior art design of FIG. 1.

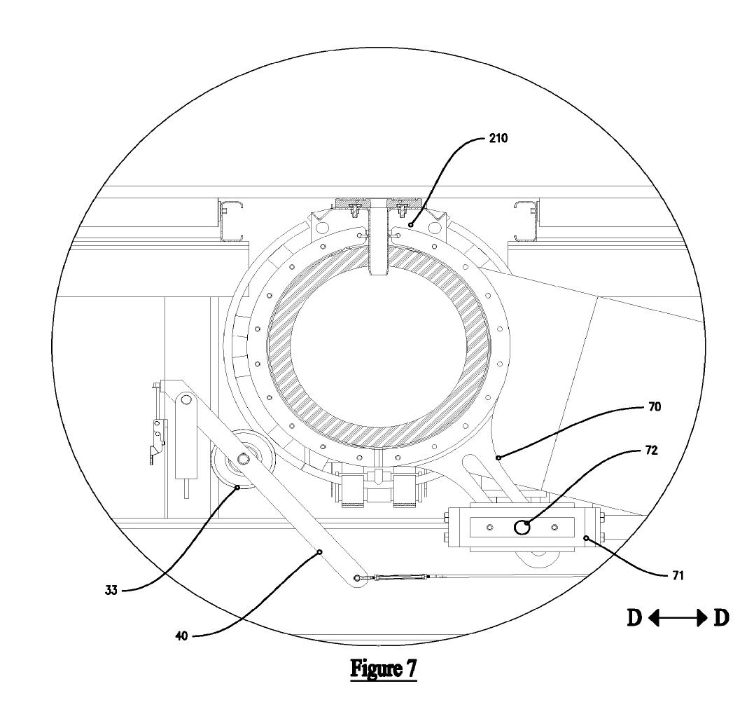

FIG. 7 shows the rotation mechanism. This consists of a rotation lever 70 and an actuation rod 71. The rotation lever 70 is connected to the assembly 210 and consists of a slot wherein a pin 72 can travel freely. The pin 72 is housed in the actuation rod 71. The actuation rod 71 can travel in the direction D [symbol] D by the use of cables, mechanical screw jacks, pneumatic cylinders, or hydraulics. This movement functions to rotate the assembly.

The movement of the swing arm 40 coupled with the movement of the rotation actuation rod 71 serves to raise or lower assembly 210 which provides for fully automatic leveling of the combined vacuum pan/filtrate manifold assembly. Such leveling is crucial to the operation of vacuum pans in that it enables the retention of the vacuum seal. In prior art systems such as those depicted in FIGS. 1 and 2 a leveling procedure is done manually by adjusting leveling nuts on the vacuum pan assembly prior to the operation of the belt filter.

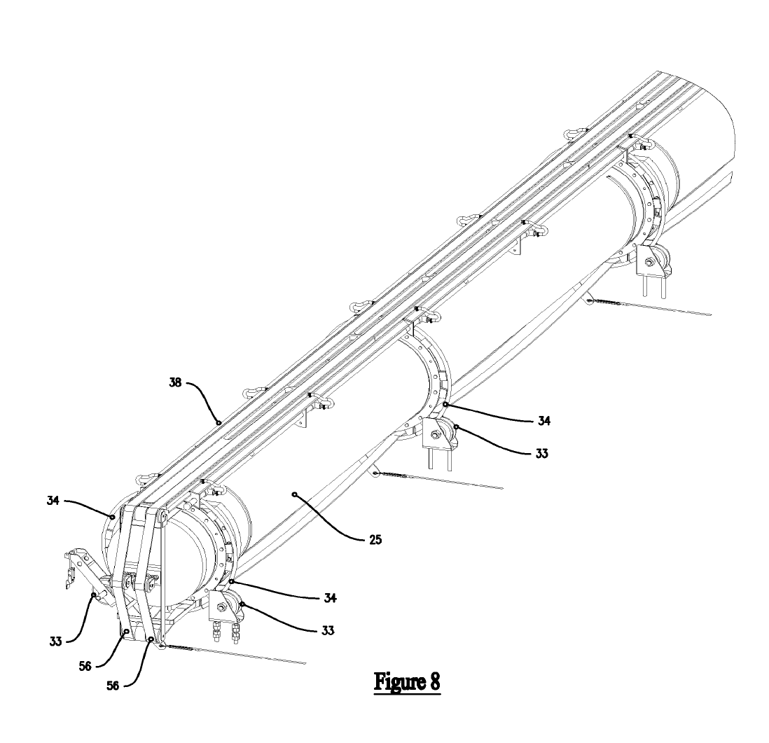

As depicted in FIG. 8, the top section of vacuum pan 38 is connected to filtrate manifold pipe section 25, the connection of which is secured by support rings 34. The support rings 34 rest on rolling support elements 33. The combined vacuum pan/filtrate manifold serves to support the continuous wear belts 56, which are guided on the top of the vacuum pan section of the combined device and are supported on the bottom of each support ring. The support rings are designed for the removal of the continuous wear belts by rotating the mechanism, preferably about ninety degrees, and removing a retainer clip at each support location. With the retainer clips removed the wear belts are able to be removed and replaced.

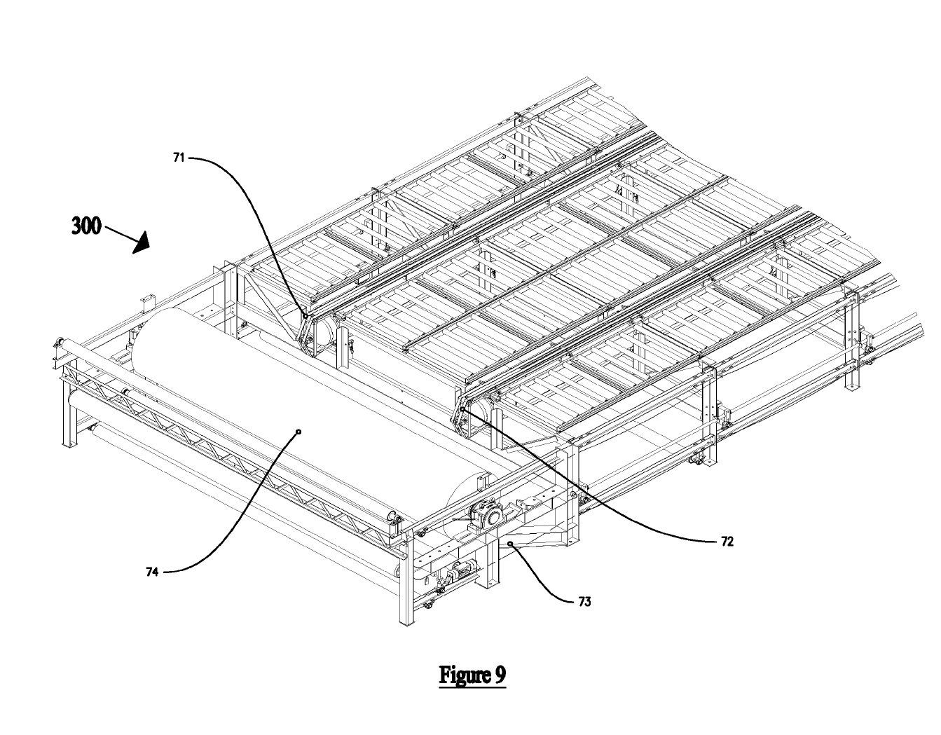

FIG. 9 depicts the slurry feed end 73 of belt filter 300 in which there is rotating drum 74. In the embodiment depicted there is utilized two combined vacuum pan and filtrate manifold devices 71 and 72 of the present invention. As depicted, when more than one vacuum pan/filtrate manifold devices of the present invention are utilized in a single belt filter, they are typically set up in parallel.

The system will utilize suitable controls, conveniently including a micro-processor to time and coordinate the various functions in accordance with the invention. Such controls are not described in detail because their function is well known.

We claim:

1. A belt filter for separating liquids from solids in a slurry feed comprising a frame supporting a porous filter medium situated over a moving carrier belt for receiving the feed and separating liquid filtrate from the feed; a vacuum pan for collecting the liquid filtrate separated from the feed; a filtrate manifold for receiving the filtrate from the vacuum pan; wherein the vacuum pan and filtrate manifold form an integral unit as described in the specification and illustrated in the Figures.

2. A belt filter for separating liquids from solids in a slurry feed comprising a frame supporting a porous filter medium arranged over a moving carrier belt, said medium adaptable to receive the feed arranged over a moving carrier belt and separate liquid filtrate therefrom; a vacuum pan for collecting liquid filtrate separated from the feed, said vacuum pan being a rectangular trough having an open end located directly underneath the carrier belt, the length of said vacuum pan being situated in the direction of movement of the carrier belt; a filtrate manifold for receiving the filtrate from the vacuum pan; wherein the filtrate manifold is attached to and located directly underneath the vacuum pan to form an integral assembly.

3. The belt filter of claim 2 wherein the filtrate manifold is cylindrical and has a longitudinal axis that runs parallel to the length of the vacuum pan.

4. The belt filter of claim 3 wherein the integral assembly further comprises means to rotate the assembly about said longitudinal axis to facilitate access to the vacuum pan.

5. The belt filter of claim 3 wherein the integral assembly further comprises means to move the assembly vertically relative to the frame.

6. The belt filter of claim 3 wherein the integral assembly further comprises means to move the assembly in a widthwise direction relative to the frame.

7. A belt filter for separating liquids from solids in a slurry feed comprising
(i) a frame;
(ii) a porous filter medium supported by the frame and arranged over a moving carrier belt, said medium adaptable to receive the feed arranged and separate liquid filtrate therefrom;
(iii) a vacuum pan for collecting liquid filtrate separated from the feed, said vacuum pan being a rectangular trough located directly underneath the carrier belt, with the length of said vacuum pan being situated in the direction of movement of the carrier belt;
(iv) a cylindrical filtrate manifold for receiving the filtrate from the vacuum pan, said filtrate having a longitudinal axis that runs parallel to the length of the vacuum pan, wherein the filtrate manifold is attached to and located directly underneath the vacuum pan to form an integral assembly;
(v) means to rotate the assembly about said longitudinal axis to facilitate access to the vacuum pan;
(vi) means to move the assembly vertically relative to the frame; and
(vii) means to move the assembly in a widthwise direction relative to the frame.

8. An integral vacuum pan and filtrate manifold assembly for use in a belt filter as described in the specification and illustrated in the Figures.

9. An integral vacuum pan and filtrate manifold assembly for use in a belt filter comprising
a vacuum pan for collecting liquid filtrate, said vacuum pan being a rectangular trough;
a cylindrical filtrate manifold for receiving filtrate from the vacuum pan, said filtrate manifold (i) being attached to and located directly underneath the vacuum pan to form an integral assembly and (ii) having a longitudinal axis that runs parallel to the length of the vacuum pan.
